(19) United States
(12) Patent Application Publication
(10) Pub. No.: US 2026/0243215 A1
(43) Pub. Date: Aug. 20, 2026

(54) Piston Bowl For An Internal Combustion Engine

(71) Applicant: Perkins Engines Company Limited, Cambridgeshire (GB)

(72) Inventors: Geoffrey Bailey, Stafford (GB); Guy Blundell, Oundle (GB)

(21) Appl. No.: 19/161,663

(22) PCT Filed: Mar. 15, 2024
(86) PCT No.: PCT/EP2024/025117

§ 371 Date: Sep. 2, 2025

(30) Foreign Application Priority Data
Mar. 21, 2023 (GB) 2304104.9

(51) Int. Cl. F02F 3/26; F02B 23/06; F02F 3/28

(52) U.S. Cl. CPC F02F 3/26; F02B 23/0672; F02F 3/28

(57) ABSTRACT

A piston crown for a piston of an internal combustion engine is disclosed. The piston crown comprises an annual portion including alternating merlons and crenels. The piston crown has a merlon step, a merlon chamfer and a merlon arc. A gradient of an actuate surface of the piston bowl adjacent to the merlon arc is tilted towards the central axis in a direction towards the first axial end. The piston crown has a crenel step and a crenel chamfer. A gradient of the actuate surface of the piston bowl adjacent to the crenel chamfer is tilted away from the central axis in a direction towards the first axial end of the piston crown.

### TECHNICAL FIELD

The disclosure relates to the field of internal combustion engines and, in particular, to internal combustion engines having increased efficiency and reduced emissions.

### BACKGROUND

Increasing engine efficiency and reducing emissions is a desire of engine manufacturers and users alike.

There is a large range of variables that influence combustion behaviour in an internal combustion engine. These variables influence efficiency, emissions and engine health, among other things. Improving piston crown design is one of the mechanisms by which combustion behaviour can be influenced in order to target one or more objectives, for example in relation to efficiency, emissions and engine health.

### SUMMARY

Against this background there is provided a piston crown for a piston of an internal combustion engine piston crown for a piston of an internal combustion engine, the piston crown extending in an axial direction along a central axis and in a radial direction outwardly from the central axis, the piston crown comprising: an annular region at a first axial end of the piston crown; and a piston bowl located radially within the annular region and recessed relative to the first axial end of the piston crown, wherein:
the piston bowl comprises:
   a raised floor in a radially central region of the piston bowl comprising a radially outer frustoconical portion and a radially inner domed portion; and
   an arcuate surface located radially outward relative to the raised floor;
the annular region comprises:
   a castellated portion comprising merlons and crenels, wherein the merlons and the crenels alternate; and
the piston crown comprises:
   a merlon step at a radially inner edge of each merlon extending between a first end of the merlon step located towards the first axial end of the piston crown and a second end of the merlon step opposite the first end of the merlon step, wherein the merlon step is parallel to the axial direction;
   a merlon chamfer extending between the second end of the merlon step and a merlon arc, the merlon arc extending between the merlon chamfer and the arcuate surface of the piston bowl, wherein a gradient of the actuate surface of the piston bowl adjacent to the merlon arc is tilted towards the central axis in a direction towards the first axial end of the piston crown so as to form an angle, α, of more than 90° with a plane orthogonal to the central axis;
   a crenel step at a radially inner edge of each crenel extending between a first end of the crenel step located towards the first axial end of the piston crown and a second end of the crenel step opposite the first end of the crenel step, wherein the crenel step is parallel to the axial direction;
      a crenel chamfer extending between the second end of the crenel step and the arcuate surface of the piston bowl, wherein a gradient of the actuate surface of the piston bowl adjacent to the crenel chamfer is tilted away from the central axis in a direction towards the first axial end of the piston crown so as to form an angle, β, of less than 90° with a plane orthogonal to the central axis.

In this way, compression ratio may be improved, combustion gasses near the cylinder liner are reduced, the end of injection limit after top dead centre is extended, and NOx and soot are reduced. Furthermore, by improving compression ratio, this enables improved cold start and cold running behaviour of the engine. Minimising combustion gasses near the cylinder liner reduces soot particles circumventing piston rings which reduces soot to oil transfer. In this way, oil volatilisation is reduced which contributes to longer oil change intervals.

### BRIEF DESCRIPTION OF THE DRAWINGS

FIG. 1 shows a compound cross section through a cylinder of an internal combustion engine, at a point in its cycle where a piston in the cylinder is furthest from a fuel injection end of the cylinder;

FIG. 2 shows a perspective view of a top part of the piston and a fuel injector at a point in its cycle where the piston is closest from the fuel injection end of the cylinder (not shown);

FIG. 3 shows both a top-down view of the piston crown orthogonal to the axis of the piston and a compound cross sectional view through the axis of the piston;

FIG. 4 shows a zoomed in portion of the piston crown of FIG. 3 focusing particularly on the merlon;

FIG. 5 shows a zoomed in portion of the piston crown of FIG. 3 focusing particularly on the crenel;

FIG. 6 shows the compound cross sectional view through the axis of the piston with dimensions and angles shown instead of reference numerals;

FIG. 7 shows the top-down view of the piston crown of FIG. 3 with dimensions shown instead of reference numerals;

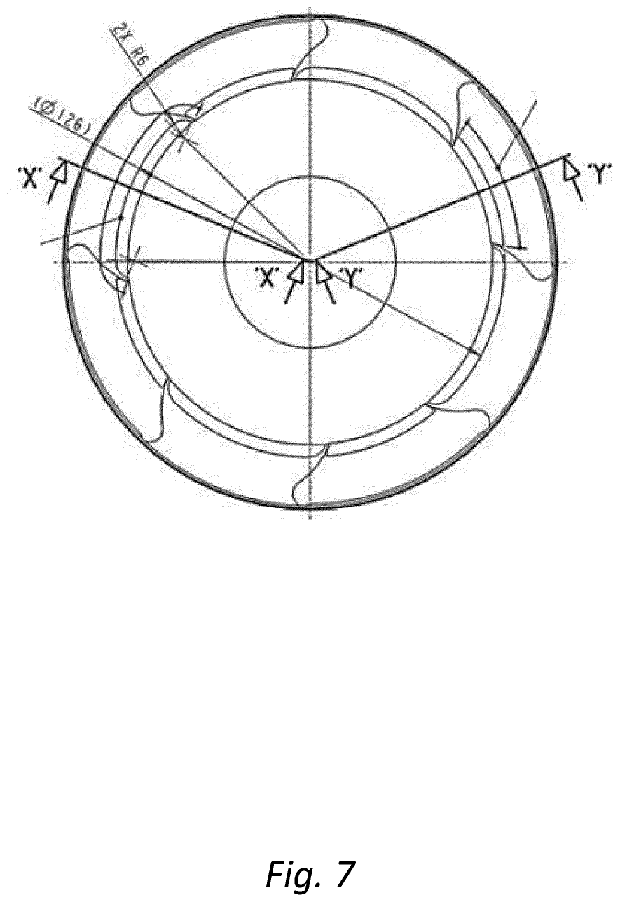

FIG. 8 shows the sectional view from FIG. 3 compared with an equivalent sectional view of a prior art piston crown for comparison;

FIG. 9 shows a plot of normalised soot rate versus end of injection for the two piston crowns of FIG. 8; and

FIG. 10 shows a plot of normalised particulate count versus normalised NOx for the two piston crowns of FIG. 8.

### DETAILED DESCRIPTION

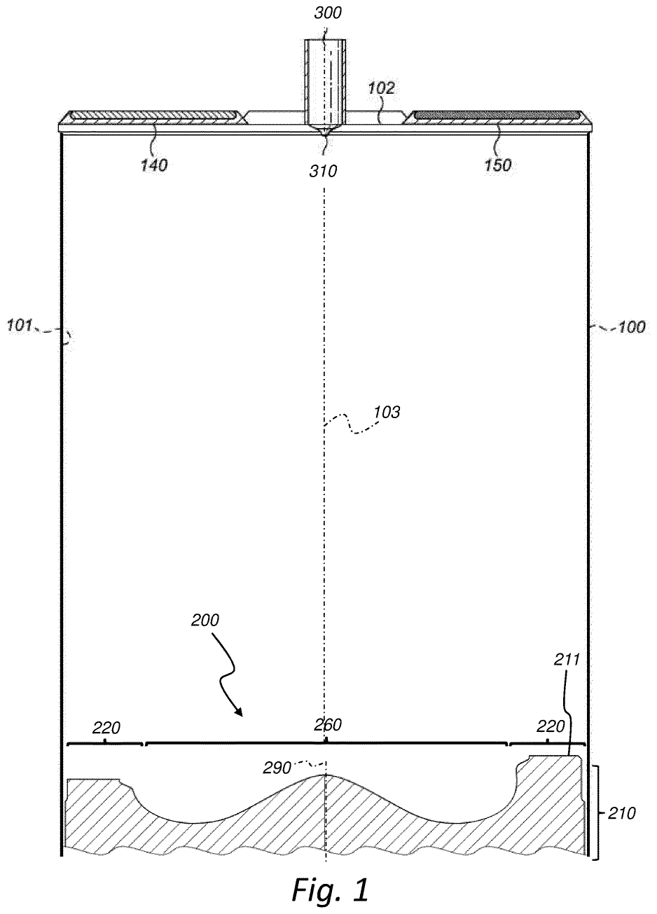

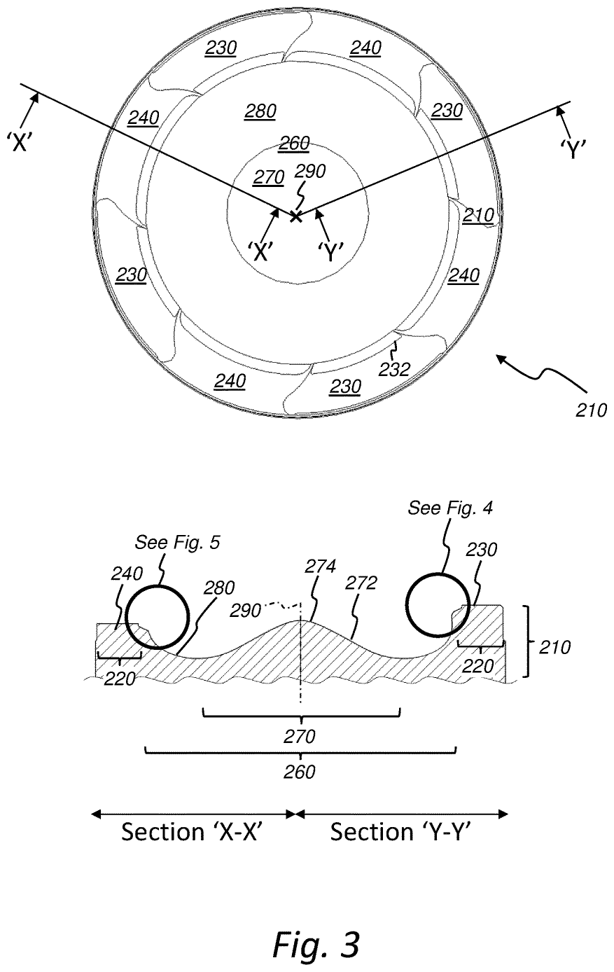

FIG. 1 shows a compound cross section through a cylinder 100 of an internal combustion engine (not shown). The nature of the compound cross section is explained further below in relation to FIG. 3. The cylinder may comprise an internal bore 101. The internal bore 101 may accommodate a piston 200. The piston 200 is coaxial with the internal bore 101 of the cylinder 100 along a longitudinal axis 103 of the internal bore 101 and a longitudinal axis 290 of the piston such that the piston 200 is movable axially relative to the cylinder 100.

The cylinder 100 may comprise a fuel injector 300 located a first axial end 102 (top end 102) of the cylinder 100. The fuel injector 300 may be located coaxially with the internal bore 101 of the cylinder. The fuel injector 300 may comprise a fuel injector head 310 for distributing fuel in accordance with a desired geometrical arrangement.

The cylinder 100 may further comprise an oxidant inlet 140 for selectively allowing inlet of an oxidant, such as air, to facilitate combustion and an exhaust outlet 150 for selectively allowing release of combustion products from the cylinder 100. The oxidant inlet 140 and the exhaust outlet 150 may be located at the top end 102 of the cylinder 100 adjacent the fuel injector 130.

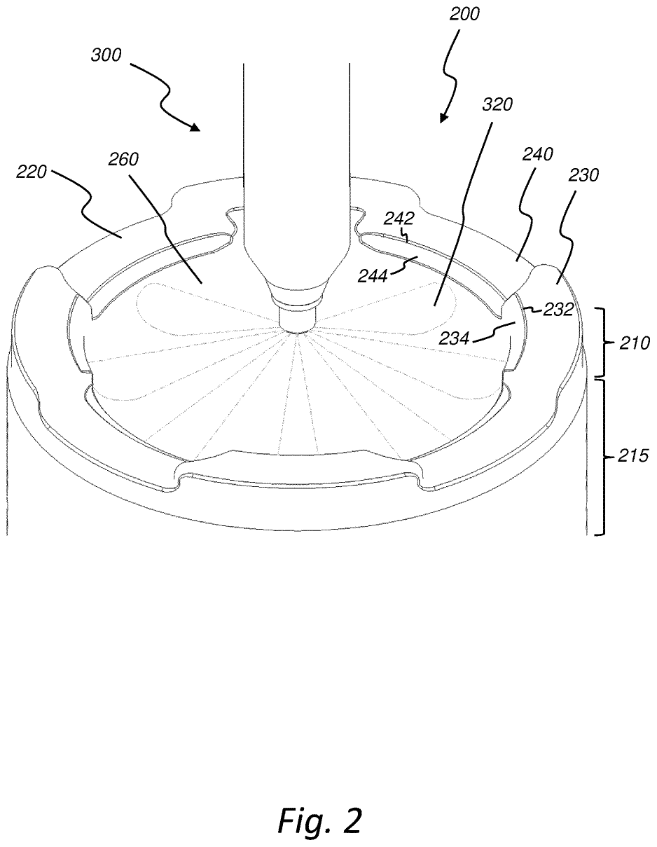

The piston 200 comprises a piston crown 210 and a piston body 215 (located underneath the piston crown 200 in the orientation as shown in FIG. 2). The piston crown 210 is at a head end of the piston 110 such that the piston crown 210 faces the fuel injector 300. A first end 211 of the piston crown 210 is closest to the top of the cylinder 100.

The piston crown 210 comprises an annular region 220 and a piston bowl 260 radially within the annular region 220. The annular region 220 is castellated, as will be explained further below. The piston bowl 260 is recessed relative to the first end 211 of the piston crown.

When the piston 200 is in situ in the cylinder, the piston crown 210 faces the fuel injector 130. In FIG. 1, the piston 200 is shown relative to the cylinder 100 at a position in its oscillating cycle that is furthest from the top end 102 of the cylinder 100.

FIG. 2 shows a perspective view of a top part of the piston 200 comprising the piston crown 210 and a part of the piston body 215 closest to the piston crown. FIG. 2 also shows part of the injector 300. By contrast with FIG. 1, FIG. 2 shows the piston 200 relative to the injector 300 as if the piston 200 were at a position in its oscillating cycle that is closest to the top end 102 of the cylinder 100.

As is clear from FIG. 2, the annular region 210 is castellated, comprising a plurality of merlons 230 and a plurality of crenels 240, wherein the merlons 230 and the crenels 240 alternate. The merlons 230 are raised relative to the crenels 240.

In FIG. 2, the broken lines show the approximate fuel spray cones 320 emitted by the injector 300 relative to the piston bowl 250. As is shown, the number of spray cones 320 may be the same as the sum of the number of merlons 230 and the number of crenels 240. Each fuel spray cone 320 may be directed to the radial centre of either a merlon 230 or a crenel 240.

More geometrical details of the piston crown 210 will now be explained with reference to FIG. 3. FIG. 3 shows both a top-down view of the piston crown 210 orthogonal to the axis 290 of the piston 200 and a compound cross sectional view through the axis 290 of the piston 200. Section X-X is through the centre of a crenel 240 while section Y-Y is through the centre of a merlon 230. Thus, the cross sectional view is compound. This explains the discontinuous nature of the compound cross sectional view at the axis 290, and the fact that the left side of the cross section is not a mirror image of the right side of the cross section.

The piston bowl 260 comprises a raised floor 270 in a radially central region of the piston bowl 260 and an arcuate surface 280 located radially outward relative to the raised floor 270. The raised floor 270 may have an approximately frusto-conical portion 272 in a radially outer portion of the raised floor 270 and have a domed portion 274 at a radially inner portion of the raised floor 270. The raised floor 270 may have an axis of symmetry coincident with the axis 290 of the piston 200.

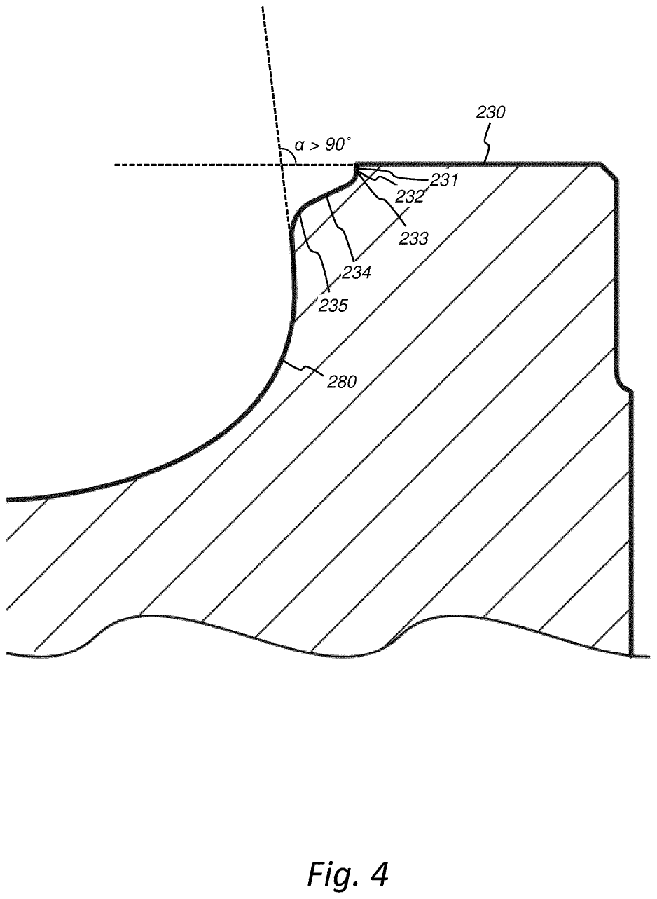

Referring to FIG. 4, which shows a zoomed in portion of the merlon 230 in context, the piston crown 210 comprises a merlon step 232 at a radially inner edge of each merlon 230 extending between a first end 231 of the merlon step 232 located towards the first axial end 211 of the piston crown 210 and a second end 233 of the merlon step 230 opposite the first end 231 of the merlon step 230.

Note that, given the relatively small dimensions of the merlon step 230 relative to the surrounding features, the first end 231 and the second end 233 of the merlon step 230 are not labelled in many of the figures. However, the first end 231 and the second end 233 of the merlon step 230 are labelled in the zoomed in view shown in FIG. 4.

With reference to FIG. 4, the piston crown 210 further comprises a merlon chamfer 234 extending between the second end 233 of the merlon step 232 and a merlon arc 235. The merlon arc 235 extends between the merlon chamfer 234 and the arcuate surface 280 of the piston bowl 260.

A gradient of the actuate surface 280 of the piston bowl 260 adjacent to the merlon arc 235 is tilted towards the central axis 290 of the piston crown 210 in a direction towards the first axial end 102 of the piston crown 210. In this way, an angle, α, between gradient of the actuate surface 280 of the piston bowl 260 adjacent to the merlon arc 235 and a plane orthogonal to the axis 290 is more than 90°. In a specific embodiment, the angle α may be 95°. The merlon arc 235 has a radius meaning that there is no discontinuity of gradient between the merlon chamfer 234 and the actuate surface 280 of the piston bowl 260.

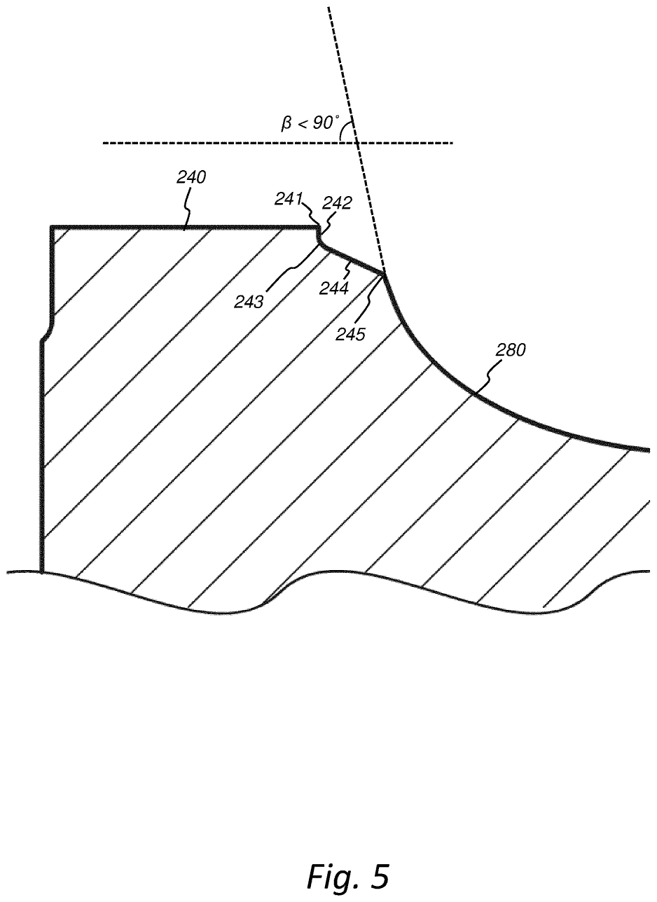

With reference to FIG. 5, the piston crown 210 further comprises a crenel step 242 at a radially inner edge of each crenel 240 extending between a first end 241 of the crenel step 242 located towards the first axial end 211 of the piston crown 210 and a second end 243 of the crenel step 242 opposite the first end 241 of the crenel step 240.

Again, given the relatively small dimensions of the crenel step 240 relative to the surrounding features, the first end 241 and the second end 243 of the crenel step 240 are not labelled in many of the figures. However, the first end 241 and the second end 243 of the crenel step 240 are labelled in the zoomed in view shown in FIG. 5.

With reference to FIG. 5, the piston crown 210 further comprises a crenel chamfer 244 extending between the second end 243 of the crenel step 242 and the arcuate surface 280 of the piston bowl. At the interface between the crenel chamfer 244 and the arcuate surface 280 is a crenel ridge 245 forming an abrupt change in gradient between a gradient of the crenel chamfer 244 and a gradient of the arcuate surface 280 adjacent to the crenel ridge 245.

A gradient of the actuate surface 280 of the piston bowl 260 adjacent to the crenel ridge 245 is tilted away from the central axis 290 of the piston crown 210 in a direction towards the first axial end 211 of the piston crown 210. In this way, an angle, β, between gradient of the actuate surface 280 of the piston bowl 260 adjacent to the crenel ridge 245 and a plane orthogonal to the axis 290 is less than 90°. In a specific embodiment, the angle β may be 79°.

The piston bowl 260 has a circular throat facing the direction of the fuel injector 300. The piston bowl 260 has a bowl throat radius, R1, defined as a distance in the radial direction between the central axis 290 of the piston crown 210 and the radially inmost portion of the annular region 220.

The piston bowl 260 has a bowl height, H, defined as a distance in the axial direction between the first end 211 of the piston crown 210 and a surface 231 of the piston bowl furthest from the first end 211 of the piston crown 210. In the illustrated embodiment the surface of the piston bowl furthest from the first end 211 of the piston crown 210 is located at a radially inner point of the arcuate surface 280 where it meets the raised floor 270.

Lip re-entrancy refers to a way in which fuel that is injected into the piston bowl with a radially outward component of velocity is redirected, at least in part by virtue of the geometry of the piston bowl, so as to gain a radially inward component of velocity.

A lip re-entrancy angle may be defined as an acute angle between a line extending in the radial direction at the first end 211 of the piston crown 120 and a tangent to the arcuate surface 280 closest to the first end 211 of the piston crown 120.

Given that the gradient of the actuate surface 280 of the piston bowl 210 adjacent to the merlon arc 235 is tilted towards the central axis 290 in a direction towards the first axial end 211 of the piston crown 210 (that is α>90)°, the piston bowl 210 provides lip re-entrancy in the regions of the merlons 230.

By contrast, given that the gradient of the arcuate surface 280 of the piston bowl 210 adjacent to the crenel chamfer 244 is tilted away from the central axis 290 in a direction towards the first axial end 211 of the piston crown 210 (that is β<90)°, the piston bowl 210 does not provide a lip re-entrancy in the regions of the crenels 230.

The following angle ranges are in accordance with the disclosure:

| | |
|---|---|
| Angle between (a) the gradient of the arcuate | Between 92° and 98°, |
| surface 280 adjacent the merlon arc 235 and | preferably 95° |
| (b) the plane orthogonal to the axis 290 | |
| Angle between (a) the gradient of the actuate | Between 76° and 82°, |
| surface 280 adjacent to the crenel ridge 245 | preferably 79° |
| and (b) the plane orthogonal to the axis 290 | |
| Angle of merlon chamfer 234 | Between 22° and 28°, |
| | preferably 25° |
| Angle of crenel chamfer 244 | Between 22° and 28°, |
| | preferably 25° |

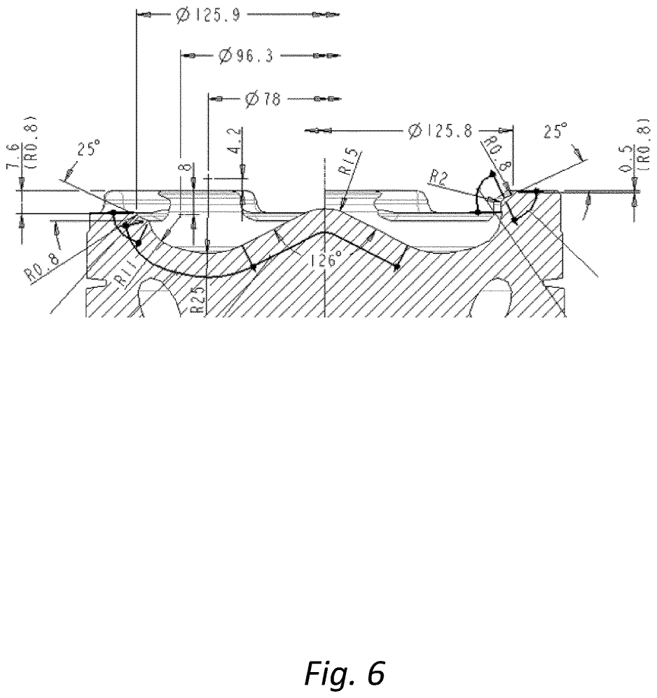

One specific exemplary piston crown in accordance with the disclosure is shown in FIG. 6. The embodiment of FIG. 6 has the following dimensions:

| Height of merlon step 232 | 0.5 | mm |
|---|---|---|
| Radius from axis 260 to merlon step 232 | 125.8 | mm |
| Radius between merlon step 232 and merlon chamfer 234 | 0.8 | mm |
| Radius of merlon arc 235 | 2 | mm |
| Height of merlon relative to crenel | 7.6 | mm |
| Height of crenel step 242 | 0.4 | mm |
| Radius from axis 260 to crenel step 242 | 125.9 | mm |
| Radius between crenel step 242 and crenel chamfer 244 | 0.8 | mm |
| Angle of frustoconical portion | 126° | |
| Radius of domed portion | 15 | mm |
| Radius (in an axial direction) of inner portion | 25 | mm |
| of arcuate surface 280 having a radial centre of | | |
| 78 from the axis of the piston crown | | |
| Radius (in an axial direction) of outer portion | 11 | mm |
| of arcuate surface 280 having a radial centre of | | |
| 96.3 from the axis of the piston crown | | |

The piston crown may be deployed in a cylinder having a bore of 160 mm and a stroke of 190 mm, with a nominal cylinder volume of 3.8 litres and a compression ratio of 14:1.

A fuel injector configured for use with the piston crown may be a mechanically actuated electronically controlled direct injector with an 8-hole fuel nozzle and a 140° cone angle.

### INDUSTRIAL APPLICATION

The geometry and profile of the piston crown 210 contribute to enhanced in-cylinder gas velocities and fuel distribution during the injection process. Lip re-entrancy within the scope of the present disclosure may result in generating local turbulence to promote air-fuel mixing. At the same time, the geometry and profile of the piston crown 210 result in reduced combustion gases near the cylinder liner. This, in turn, reduces the risk of soot contaminating the lubricating oil or circumventing piston rings. Hot combustion gases adjacent to the oil on the liner lead to increased oil volatilisation, so reducing the hot combustion gas adjacent the liner can facilitate longer oil change intervals and more reliable engine operation. Other aspects of geometry help to contribute to increased uniformity and balance in fuel distribution via spray/bowl interactions. Increased in-cylinder air turbulence results in more rapid mixing of air and fuel. This increases the proportion of fuel that combusts within the cylinder.

Aspects of the disclosure may be particularly relevant to direct injection compression ignition engines fitted with high pressure fuel systems as in common rail in which the injection of fuel at high pressure may cause it to atomise readily for dispersion by turbulence of fluid in the combustion chamber.

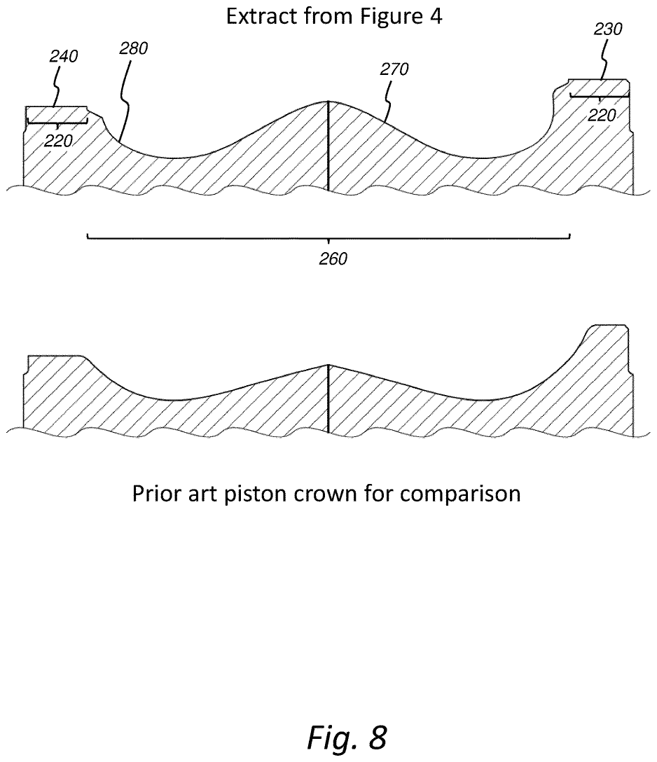

FIG. 8 shows the piston crown of FIG. 4 alongside a prior art piston crown. The prior art piston crown has crenels and merlons but no steps or chamfers. The prior art piston crown has no domed portion and has a conical portion rather than a frusto-conical portion.

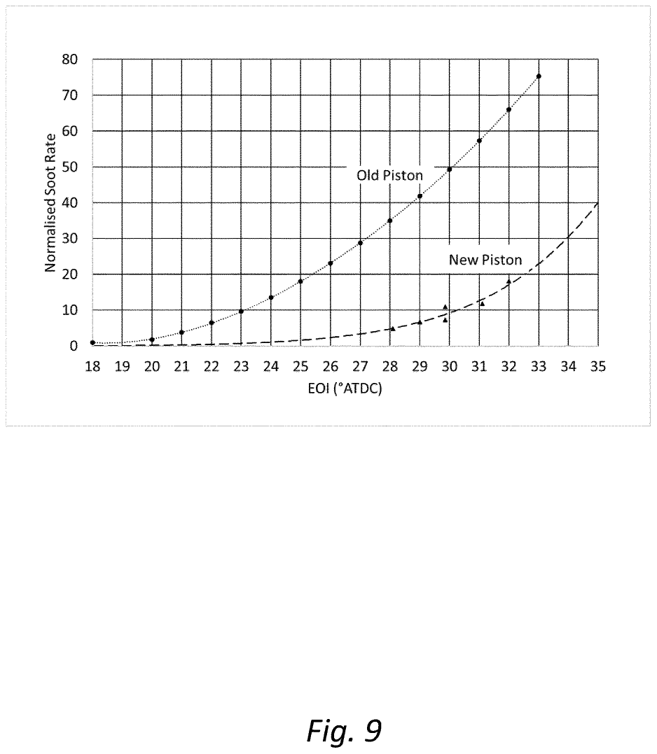

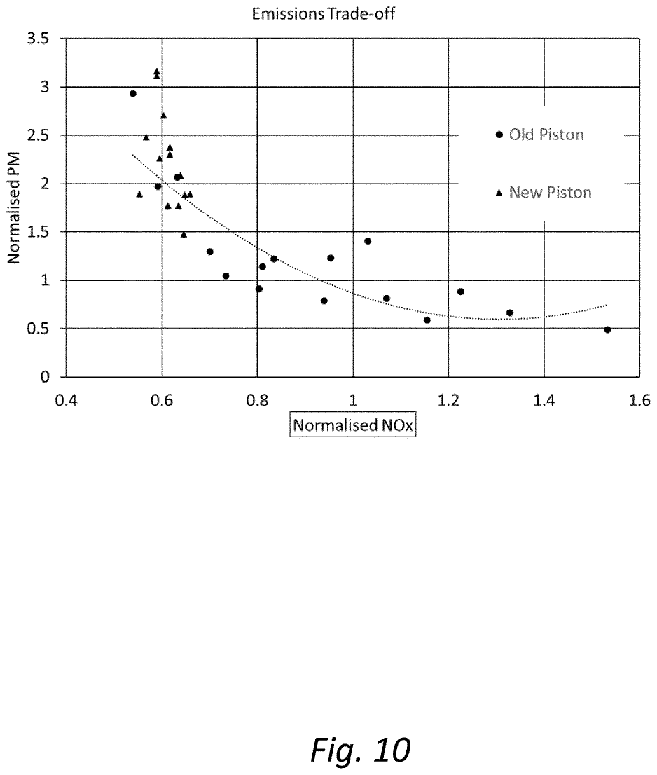

FIGS. 9 and 10 show data for the piston crowns of FIG. 8. FIG. 9 shows a plot of normalised soot rate relative to end of injection timing after top dead centre. It is clear that for all end of injection timings the normalised soot rate is significantly lower for the piston crown of the present disclosure relative to the prior art piston crown. This allows for delayed injection whilst still releasing less soot from the cylinder. FIG. 10 shows a plot of normalised particulates versus normalised NOx, again showing the advantages of the piston crown of the present disclosure relative to the prior art piston crown.

Since the reduction in unburnt fuel has been shown to apply over a wide range of injection timings (see FIG. 8), use of the piston bowl of the present disclosure provides greater tolerance to injection retard. Furthermore, a trade-off between soot and NOx emissions is also improved (see FIG. 10).

In short, the piston crown 210 of the present disclosure results in a favourable combination of power output, fuel consumption, reduced emissions and improved oil health.

1. A piston crown for a piston of an internal combustion engine, the piston crown extending in an axial direction along a central axis and in a radial direction outwardly from the central axis, the piston crown comprising: an annular region at a first axial end of the piston crown; and a piston bowl located radially within the annular region and recessed relative to the first axial end of the piston crown, wherein:
the piston bowl comprises:
a raised floor in a radially central region of the piston bowl comprising a radially outer frustoconical portion and a radially inner domed portion; and
an arcuate surface located radially outward relative to the raised floor;
the annular region comprises:
a castellated portion comprising merlons and crenels, wherein the merlons and the crenels alternate; and
the piston crown 210 comprises:
a merlon step at a radially inner edge of each merlon extending between a first end of the merlon step located towards the first axial end of the piston crown and a second end of the merlon step opposite the first end of the merlon step, wherein the merlon step is parallel to the axial direction;
a merlon chamfer extending between the second end of the merlon step and a merlon arc, the merlon arc extending between the merlon chamfer and the arcuate surface of the piston bowl, wherein a gradient of the actuate surface of the piston bowl adjacent to the merlon arc is tilted towards the central axis in a direction towards the first axial end of the piston crown so as to form an angle, α, of more than 90° with a plane orthogonal to the central axis;
a crenel step at a radially inner edge of each crenel extending between a first end of the crenel step located towards the first axial end of the piston crown and a second end of the crenel step opposite the first end of the crenel step, wherein the crenel step is parallel to the axial direction;
a crenel chamfer extending between the second end of the crenel step and the arcuate surface of the piston bowl, wherein a gradient of the actuate surface of the piston bowl adjacent to the crenel chamfer is tilted away from the central axis in a direction towards the first axial end of the piston crown so as to form an angle, β, of less than 90° with a plane orthogonal to the central axis.

2. The piston crown of claim 1 wherein the angle α is between 92° and 98°.

3. The piston crown of claim 1 wherein angle β is between 76° and 82°.

4. The piston crown of claim 1 wherein the crenel chamfer and the arcuate surface meet at a crenel ridge that provides a discontinuity between the gradient of the actuate surface of the piston bowl adjacent to the crenel chamfer and the gradient of the crenel chamfer.

5. The piston crown of claim 1 wherein a gradient of the merlon chamfer has an angle of between 22° and 28° relative to the plane orthogonal to the central axis.

6. The piston crown of claim 1 wherein a gradient of the crenel chamfer has an angle of between 22° and 28° relative to the plane orthogonal to the central axis.

7. The piston crown of claim 1 wherein:
a transition between the merlon step at the second end of of the merlon step and the merlon chamfer has a radius of approximately 0.8 mm; and/or
a transition between the crenel step at the second end of the crenel step and the crenel chamfer has a radius of approximately 0.8 mm.

8. The piston crown of claim 1 wherein the merlons extend to the first axial end of the piston crown.

9. The piston crown of claim 1 wherein the raised floor in the radially central region of the piston bowl is recessed relative to the first axial end of the piston crown.

10. The piston crown of claim 1 wherein the raised floor in the radially central region of the piston bowl extends closer to the first axial end of the piston crown than the crenels.

11. The piston crown of claim 1 wherein the frustoconical portion of the raised floor has an angle of 126° and the domed portion has a radius of 15 mm.

12. The piston crown of claim 1 wherein the castellated portion comprising merlons and crenels comprises four merlons and four crenels.

13. A cylinder for an internal combustion engine comprising a piston having a piston crown in accordance with claim 1 and a fuel injector configured to inject fuel from a plurality of nozzles, each nozzle having an axial component of direction and a radial component of direction;
wherein the plurality of nozzles comprises twice as many nozzles as merlons.

14. The cylinder of claim 13 wherein a bore of the cylinder is 160 mm, a stroke of the cylinder is 190 mm, and a nominal cylinder volume is 3.8 litres.

15. The cylinder of claim 14 wherein the fuel injector has a 140° spray cone angle.
